(19) United States
(12) Patent Application Publication
(10) Pub. No.: US 2026/0222778 A1
(43) Pub. Date: Jul. 30, 2026

(54) CONFEDERATION NETWORK (CONET) MANAGEMENT FOR MULTIPLE PLAYERS

(71) Applicant: Huawei Technologies Co., Ltd., Shenzhen (CN)

(72) Inventors: Wei Tan, Shanghai (CN); Hang Zhang, Ottawa (CA)

(21) Appl. No.: 19/630,202

(22) Filed: Mar. 26, 2026

Related U.S. Application Data
(63) Continuation of application No. PCT/CN2024/082231, filed on Mar. 18, 2024.
(60) Provisional application No. 63/586,520, filed on Sep. 29, 2023.

(51) Int. Cl. H04W 4/50; H04W 64/00

(52) U.S. Cl. CPC H04W 4/50; H04W 64/00

(57) ABSTRACT

Example embodiments relate to methods systems and apparatuses for managing a chain for multiple players. An XaaS entity of an XaaS service may request for uploading data to the blockchain by sending a first request to a first function, such as a CCF, and accordingly, the CCF may trigger setting up a chain on the blockchain and notify to the XaaS entity of information about the chain. The XaaS entity may upload its data to the chain according to a first response from the CCF.

### CROSS-REFERENCE TO RELATED APPLICATIONS

This application is a continuation of International Patent Application No. PCT/CN2024/082231, filed on Mar. 18, 2024, which claims the benefits of U.S. Provisional Application No. 63/586,520, filed on Sep. 29, 2023, the disclosures of which are hereby incorporated by reference in their entireties.

### TECHNICAL FIELD

Example embodiments of the present disclosure relate generally to the field of communications including a radio access network (RAN) and a core network (CN), and in particular, to confederation network (CONET) management for multiple players.

### BACKGROUND

Current wireless communication systems (also referred to as wireless systems), such as 5th Generation (5G) systems defined by the 3rd Generation Partnership Project (3GPP), are designed to provide connectivity services. It is anticipated that future wireless systems (e.g. 6th Generation (6G) systems defined by the 3GPP) will go beyond connectivity provisioning to offer various new services, such as artificial intelligence and data management services. It is also anticipated the future wireless system may be operated by multiple parties, for example with different parties operating a different portion of the wireless system to offer certain services. These services may be provided for the system's (e.g. operating party's) internal use or for an end customer's use. The different parties, such as telecommunication operators and vertical service providers, may have their own interests and agendas, which may potentially compete or conflict with the interests and agendas of others.

### SUMMARY

In general, example embodiments of the present disclosure provide a solution for managing a chain for multiple players.

In a first aspect, there is provided a method performed by a first function. The method comprises: receiving, from a second function associated with an anything as a service (XaaS) service, a first request for uploading data of an XaaS entity of the XaaS service to a blockchain; triggering setting up a chain on the blockchain, wherein the chain corresponds to a group comprising a plurality of members, and one of the plurality of members is the XaaS service; and transmitting, to the second function, a first response indicating to the XaaS entity to upload the data to the chain on the blockchain. As such, the XaaS entity can upload its data to the blockchain based on the first response from the first function, that is, the first function (such as the CCF) may perform a management for a chain on the blockchain, and therefore, a credible solution may be guaranteed.

In some example embodiments, triggering setting up of the chain comprises: transmitting, to the blockchain, a second request for setting up the chain, wherein the second request comprises data information of the XaaS entity; and receiving, from the blockchain, a second response indicating that the chain has been set up on the blockchain. As such, the chain for uploading the data may be set up based on a second request.

In some example embodiments, the second response indicates at least one of: a chain name of the chain, a chain ID of the chain, a chain performance of the chain, or location information of the chain on the blockchain. As such, some information about the chain on the blockchain may be obtained from the blockchain, therefore, the uploading operation may be enabled accordingly.

In some example embodiments, the method further comprises: transmitting, to the second function, a third request for data information of the XaaS entity; and receiving, from the second function, a third response comprising the data information of the XaaS entity. As such, data information of the XaaS entity may be obtained by the first function via the third response, accordingly a chain profile of the chain may be determined or updated.

In some example embodiments, the data information of the XaaS entity comprises at least one of: a type of the data of the XaaS entity, a topology of the data, a security level of the data, or a performance request of the data. As such, the data information of the XaaS entity may be used for requesting chain performance from the blockchain, determining chain profile, and determining chain management information.

In some example embodiments, triggering setting up of the chain comprises: generating a chain profile of the chain, wherein the chain profile comprises at least one of: a chain name, a chain ID, a list of chain requirements, a list of chain performances, or a list of upload methods. As such, a chain profile may be generated, and thus the chain may be controlled by the CCF accordingly.

In some example embodiments, wherein triggering setting up of the chain comprises: determining chain management information of the chain, wherein the chain management information comprises a plurality of entries, a first entry of the plurality of entries is associated with the data of the XaaS entity. In some examples, the first entry comprises at least one of: a service name of the XaaS service, a service ID of the XaaS service, an entity ID of the XaaS entity, a group ID of the group, a chain ID of the chain, a type of the data of the XaaS entity, a topology of the data, a security level of the data, a performance request of the data, a chain performance of the data, or an upload method for the data. As such, chain management information may be maintained or recorded at the first function, and it facilitates a management for chain related information at the first function.

In some example embodiments, the method further comprises: before triggering setting up of the chain: performing a verification of identity information of the XaaS entity. As such, the verification of the XaaS entity may be checked, and accordingly a security may be guaranteed.

In some example embodiments, the first response indicates at least one of: a chain name of the chain, a chain ID of the chain, location information of the chain on the blockchain, or an upload method for uploading the data. As such, some detailed information about the chain may be provided to the XaaS entity by the first response, therefore, the uploading by the XaaS entity may be enabled.

In some example embodiments, the method further comprises: receiving, from the second function associated with the XaaS service, a group join request comprising profile information of the XaaS service; and establishing the group based on the group join request. As such, a group may be set up by the first function based on a group join request from an Xaas service, and accordingly, the first function may manage the group which includes at least the XaaS service.

In some example embodiments, the method further comprises: generating group information for the group, wherein the group information indicates at least one of: a group name, a group ID, the plurality of members, or a plurality of member IDs of the plurality of members. As such, details of the group may be recorded by the group information, thus it facilitates a management for multiple members in the group at the CCF.

In some example embodiments, the method further comprises: transmitting, to each member in the group, a notification comprising the group information. As such, each member in the group may be aware of the update of the group, for example, each member may know that the XaaS service will be added into the group.

In some example embodiments, the establishing is performed based on at least one of: a verification of identity information of the XaaS service, or a confirmation from each of the plurality of members. As such, the group may be established when a verification or confirmation is made, therefore a safety of the group may be guaranteed.

In some example embodiments, the profile information of the XaaS service indicates at least one of: a service name of the XaaS service, a service ID of the XaaS service, one or more entity names of one or more entities which the XaaS service comprises, one or more entity IDs of the one or more entities, entity information of the one or more entities, deployment information associated with at least one valid entity in the one or more entities, role information of each of the one or more entities, an action list for each of the one or more entities, or a requirement of the XaaS service. As such, details of an XaaS service may be recorded as the profile information, thus it facilitates a management for XaaS services at the CCF.

In a second aspect, there is provided a method performed by a second function associated with an XaaS service. The method comprises: transmitting, to a first function, a first request for uploading data of an XaaS entity of the XaaS service to a blockchain; receiving, from the first function, a first response indicating to the XaaS entity to upload the data to a chain on the blockchain, wherein the chain corresponds to a group comprising a plurality of members, and one of the plurality of members is the XaaS service; and uploading, based on the first response, the data to the chain on the blockchain.

In some example embodiments, the method further comprises: receiving, from the first function, a third request for data information of the XaaS entity; and transmitting, to the first function, a third response comprising the data information of the XaaS entity. In some examples, the data information of the XaaS entity comprises at least one of: a type of the data of the XaaS entity, a topology of the data, a security level of the data, or a performance request of the data.

In some example embodiments, the first response indicates at least one of: a chain name of the chain, a chain ID of the chain, location information of the chain on the blockchain, or an upload method for uploading the data.

In some example embodiments, chain management information of the chain is stored at the first function, wherein the chain management information comprises a plurality of entries, a first entry of the plurality of entries is associated with the data of the XaaS entity.

In some example embodiments, the first entry comprises at least one of: a service name of the XaaS service, a service ID of the XaaS service, a group ID of the group, a chain ID of the chain, an entity ID of the XaaS entity, a type of the data of the XaaS entity, a topology of the data, a security level of the data, a performance request of the data, a chain performance of the data, or an upload method for the data.

In some example embodiments, the method further comprises: determining to join a group managed by the first function; and transmitting, to the first function, a group join request comprising profile information of the XaaS service.

In some example embodiments, the method further comprises: receiving, from the first function, a notification comprising group information of the group established based on the group join request, wherein the group information indicates at least one of: a group name, a group ID, the plurality of members, or a plurality of member IDs of the plurality of members.

In some example embodiments, the profile information of the XaaS service indicates at least one of: a service name of the XaaS service, a service ID of the XaaS service, one or more entity names of one or more entities which the XaaS service comprises, one or more entity IDs of the one or more entities, entity information of the one or more entities, deployment information associated with at least one valid entity in the one or more entities, role information of each of the one or more entities, an action list for each of the one or more entities, or a requirement of the XaaS service.

It is to be understood that the technical effects discussed with reference to the first aspect above may also to applied to various embodiments of the second aspect, which will not be repeated herein for brevity.

In a third aspect, there is provided an apparatus. The apparatus comprises: a receiving module configured to receive, from a second function associated with an XaaS service, a first request for uploading data of an XaaS entity of the XaaS service to a blockchain; a processing module configured to trigger setting up a chain on the blockchain, where the chain corresponds to a group comprising a plurality of members, and one of the plurality of members is the XaaS service; and a transmitting module configured to transmit, to the second function, a first response indicating to the XaaS entity to upload the data to the chain on the blockchain. The apparatus may comprise respective modules for implementing the methods in the first aspect, for ease of brevity, the detailed description will not be listed herein.

In a fourth aspect, there is provided an apparatus. The apparatus comprises: a transmitting module configured to transmit, to a first apparatus, a first request for uploading data of an XaaS entity of the XaaS service to a blockchain; a receiving module configured to receive, from the first function, a first response indicating to the XaaS entity to upload the data to a chain on the blockchain, where the chain corresponds to a group comprising a plurality of members, and one of the plurality of members is the XaaS service; and a processing module configured to upload, based on the first response which is received from the receiving module, the data to the chain on the blockchain. The apparatus may comprise respective modules for implementing the methods in the second aspect, for ease of brevity, the detailed description will not be listed herein.

In a fifth aspect, there is provided a method, comprising: transmitting, by a second function associated with an XaaS service to a first function, a first request for uploading data of an XaaS entity of the XaaS service to a blockchain; receiving, by the first function from the second function, the first request; triggering, by the first function, setting up a chain on the blockchain, wherein the chain corresponds to a group comprising a plurality of members, and one of the plurality of members is the XaaS service; transmitting, by the first function to the second function, a first response indicating to the XaaS entity to upload the data to the chain on the blockchain; receiving, by the second function from the first function, the first response indicating to the XaaS entity to upload the data to the chain on the blockchain, where the chain corresponds to a group comprising a plurality of members, and one of the plurality of members is the XaaS service; and uploading, by the second function based on the first response, the data to the chain on the blockchain.

In a sixth aspect, there is provided a communication device, comprising: a processor configured to perform, with a transceiver, at least the method in the first aspect.

In a seventh aspect, there is provided a communication device, comprising: a processor configured to perform, with a transceiver, at least the method in the second aspect.

In an eighth aspect, there is provided a system, comprising: an apparatus in the third aspect and an apparatus in the fourth aspect. The system may be configured to implement the method in the fifth aspect.

In a ninth aspect, there is provided a non-transitory computer readable medium having program instructions stored thereon, for causing an apparatus to perform at least the method in the first or second aspect.

In a tenth aspect, there is provided a computer program comprising instructions, which, when executed by an apparatus, cause the apparatus at least to perform the method in the first or second aspect.

It is to be noted that the technical effects of the first aspect of the embodiments of the first aspect are also applied for each of the second aspect to the tenth aspect, thus the technical effects for the second to tenth aspects will not be redundantly described herein.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates a simplified schematic illustration of a communication system in accordance with some example embodiments of the present disclosure;

FIG. 2 illustrates units or modules in a device in accordance with some example embodiments of the present disclosure;

FIG. 3 illustrates the 6G system conceptual structure in accordance with some example embodiments of the present disclosure;

FIG. 4 illustrates an example CONET architecture in which some example embodiments of the present disclosure may be implemented;

FIG. 5A illustrates an example framework of elements related to CONET in accordance with some example embodiments of the present disclosure;

FIG. 5B illustrates a framework of main elements related to CONET in accordance with some example embodiments of the present disclosure;

FIG. 6 illustrates a group setup process in accordance with some embodiments of the present disclosure;

FIG. 7 illustrates an example process for uploading to a chain in accordance with some embodiments of the present disclosure;

FIG. 8 illustrates another example process for uploading to a chain in accordance with some embodiments of the present disclosure;

FIG. 9 illustrates a flowchart of an example method implemented at a first function in accordance with some embodiments of the present disclosure;

FIG. 10 illustrates a flowchart of an example method implemented at a second function in accordance with some embodiments of the present disclosure;

FIG. 11 illustrates a simplified block diagram of an apparatus according to some example embodiments of the present disclosure;

FIG. 12 illustrates a simplified block diagram of an apparatus according to some example embodiments of the present disclosure; and

FIG. 13 illustrates an example block diagram of a device that may be used to implement some embodiments of the present disclosure.

Throughout the drawings, the same or similar reference numerals represent the same or similar elements.

### DETAILED DESCRIPTION OF THE ILLUSTRATIVE EMBODIMENT

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “anything as a service (XaaS)” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and inter-connectable with one another, generally without requiring retrofit or redesign. An open system architecture is one approach for achieving a modular design in which modules are configured to be interoperable. An open system architecture can involve modules which are responsive in a known manner to known inputs, for example to perform actions or provide responses to queries, inputs or stimuli in a predictable (possibly standardized) manner. Modules in an open system architecture can provide functionalities as a service in that they respond to inputs or stimuli in a particular way, thus providing such functionalities. A service may be provided by a server to a client, and thus the “as service” model may involve a server-client model.

An open system architecture may be used to provide any one or more of a variety of services, centric to any one of a variety of entities such as providers or users, to support various operating scenarios. The architecture may further provide for a scalable system, allowing for dynamically enabling or delivering a variety of currently known and to-be-determined services without necessarily modifying or redesigning the overall system architecture.

Many new trends will trigger the consideration and design of 6G or future wireless networks:
New network infrastructure capability, e.g., cloud natured/friendly infrastructures that are broadly deployed.
New (relative) matured techniques, e.g., artificial intelligence (AI) large scale models, Data de-privacy, Block chain, etc. that have made significant progresses and significantly impact on the entire society and human life.
New apps and services, e.g., AI services, Data (sensing) service, Digital world service, etc. that are broadly applied in industry/business and used by individual customers.
More global/open/collaborative operation trend, i.e., a more open and more collaborative operation mode are becoming common practice in many fields.

New expectation and stricter requirements on future networks also drive rethinking and development of new generation of wireless networks. These requirements include: privacy and trustworthiness, simplified standardization, rapid deployment, etc. All of the above drives 6G network architecture research work.

The proposed 6G network architecture may following key design principles of 6G system: service based architecture, and/or cloud-native infrastructures (network virtualization). Some requirements to 6G system network architecture design are listed as examples. For example, the proposed 6G network architecture needs to support new 6G services which could be developed/deployed by 3rd parties. For example, the proposed 6G network architecture needs to embrace more open ecosystem to open door to technical capable 3rd parties. For example, the proposed 6G network architecture needs to enable better trustworthiness management. In this event, a solution to enable above requirements is needed.

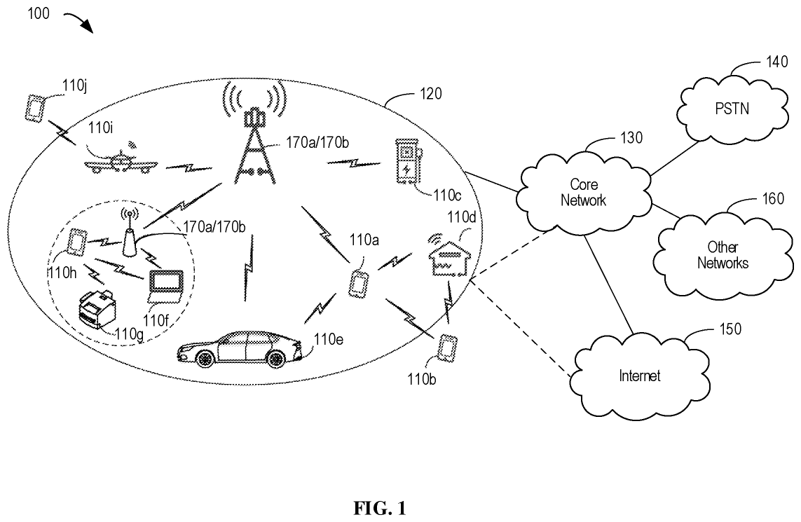

Referring to FIG. 1, as an illustrative example without limitation, a simplified schematic illustration of a communication system 100 is provided. The communication system 100 comprises a radio access network 120. The radio access network 120 may be a next generation (e.g. 6G or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system 100 and may be dependent or independent of the radio access technology used in the communication system 100. Also the communication system 100 comprises a public switched telephone network (PSTN) 140, the internet 150, and other networks 160.

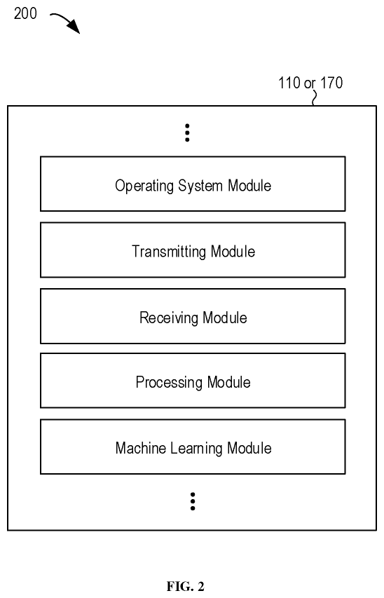

One or more steps of the embodiment methods provided herein may be performed by corresponding units or modules, according to FIG. 2. FIG. 2 illustrates units or modules in a device 200, such as in an ED 110 or a network node 170. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit, such as a programmed field-programmable gate array (FPGA), a graphics processing unit (GPU), or an application specific integrated circuit (ASIC). It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

The solution described in the present disclosure is applicable to a next generation (e.g. 6G or later) network, or a legacy (e.g. 5G, 4G, 3G or 2G) network. The proposed 6G system architecture is defined to support 6G XaaS services by using techniques such as Network Function Virtualization and Network Slicing. The 6G system architecture utilizes service-based interactions between 6G services.

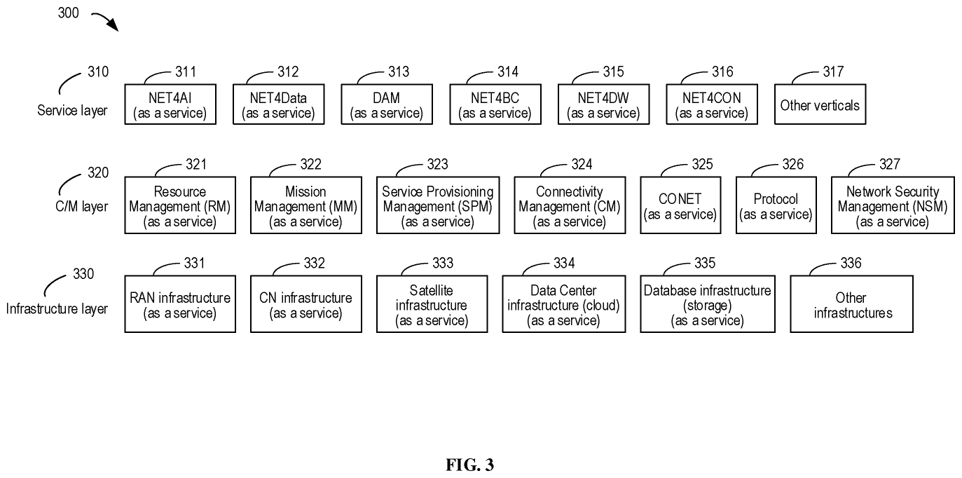

The 6G system leverages service-based architecture and XaaS concept, where XaaS services in the 6G system are categorized into three layers. FIG. 3 illustrates the 6G system conceptual structure 300 including a service layer 310, a control and management (C/M) layer 320, and an infrastructure layer 330.

Infrastructure layer 330 includes infrastructures supporting 6G services. Among them are RAN infrastructure 331, CN infrastructure 332, satellite infrastructure 333, data center infrastructure 334, database infrastructure 335, and other infrastructures 336. For example, the RAN infrastructure 331 and the CN infrastructure 332 together may refer to wireless networks infrastructures, the data center infrastructure 334 may refer to a cloud infrastructure, the database infrastructure 335 may refer to a storage infrastructure, and other infrastructures 336 may include sensing networks, etc. These infrastructures can be provided by a single provider or by multiple providers.

Each of the infrastructures could have its control and management functions, denoted as C/M functions, for infrastructure management. Each of these infrastructures is one type of Infrastructure as a Service.

C/M layer 320 includes control and management services of the 6G system. They are developed and deployed by using slicing techniques and utilizing resource provided by the infrastructure layer 330. 6G services in the C/M layer 320 include: resource management (RM) 321 as a service, mission management (MM) 322 as a service, service provisioning management (SPM) 323 as a service, connectivity management (CM) 324 as a service, Confederation NETwork (CONET) 325 as a service, protocol 326 as a service, and network security management (NSM) 327 as a service. For purposes of this disclosure, the term ‘CONET’ may also be referred to as CONsortium of NETworks.

Resource management 321 as a service provides a capability of life-cycle management of a variety of slices and over-the-air resource assignment to wireless devices.

A 6G mission is defined as a service provided to customers by the 6G system. A mission can be a type of services which is provided by a single 6G XaaS service or a type of services that needs contributions from multiple XaaS services. Mission management 322 as a service provides a capability to program provisioning of XaaS services at service layer 310 to provide mission services.

Service provisioning management 323 as a service provides a capability of control and management of 6G service access by customers and provisioning of requested services. The capability is provided by unified mutual authentication, authorization and policy, key management, quality of service (QoS) assurance and charging between any pair of XaaS service provider and customer. The customers include end-customers not only in physical world, but also digital representatives in digital world.

Connectivity management 324 as a service leverages 5G connectivity management functions, but with extension to include digital world.

Confederation network 325 as a service provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G system operations.

Protocol 326 as a service provides a capability to design service customized protocol stacks for identified interfaces. The protocol stacks could be pre-defined for on-demand selection, or could be on-demand designed.

Network security management 327 as a service provides a capability for owners of infrastructures to detect potential security risks of their infrastructures.

XaaS services in the C/M layer 320 support control and management of the 6G system itself and also provide support to verticals if requested. One example is that RM service can serve RAN for over-the-air resource management and can also provide service to a vertical for the vertical's over-the-air resource allocation to its end-customers. The XaaS in C/M layer 320 can be deployed by using slicing technique.

Service layer 310 includes 6G services which provide services to customers. In the 6G system conceptual structure, a network for AI (NET4AI) 311 as a service, a network for data (NET4Data) 312 as a service, a data analytics and management (DAM) 313 as a service, a network for blockchain (NET4BC) 314 as a service, a network for digital world (NET4DW) 315 as a service, a network for connectivity (NET4CON) 316 as a service, and other verticals 317 are shown in FIG. 3.

AI service is denoted as NET4AI 311 as a service. AI service provides AI capability to support a variety of AI applications.

Service of storage and sharing of data is denoted as NET4Data 312 as a service, this service provides a capability to trustworthily storage and share data under the control of owners of data and following recognized authorities' regulations on control of identified data.

Service of data collection, data sanitization, data analysis and data delivery are denoted as DAM 313 as a service, this service provides a capability of lifecycle management of statistic data, including acquisition, de-privatization, analysis and delivery of data which are information statistic data from any types of sensors, devices, network functions, and etc.

The 6G block chain service is denoted as NET4BC 314 as a service. This service provides a capability to support 6G block chain services.

Service to provide digital world is denoted as NET4DW 315 as a service, digital world service provides a capability to construct, control and manage digital world. Digital world is defined as digital realization of physical world.

Enhanced connectivity service, e.g., NET4CON 316 as a service, provides a capability to support exchange of messages and data among new 6G services.

All XaaS services at the service layer 310 are developed and deployed by using resource provided in infrastructure and utilizing Network Function Virtualization and Slicing techniques. The capability of each of 6G services is provided by its control and management functions and service specific data process functions.

In addition to support 6G XaaS services at the service layer 310, 6G system leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G system could also be mutual customer and provider of each other. Some of examples are that an infrastructure owner provides its resource to XaaS services in service layer 310 and C/M layer 320; RM services may need the capabilities provided by NET4AI 311, DAM 313, and NET4DW 315 for its resource management for vertical slicing; CONET 325 service and NET4Data 312 service may need the capability provided by NET4BC 314 for their operation.

Key concepts of 6G system may include the following aspects.

Define Basic XaaS Services by decoupling comprehensive types of services into basic XaaS services. A basic XaaS service provides unique capability to enable a specific type of service, such as NET4AI 311 service, NET4DW 315 service, DAM 313 service, NET4Data 312 service, Block chain 314 service, mission management 322 service, etc.

Allow joint operation of the 6G system by multiple partners.

Define data plane of the 6G system which includes processing functions of data plane of XaaS services. Programing the interconnection of these functions, by mission management service, enables to support a variety of customized customer services.

Simplify 6G system architecture by categorizing basic control services and management services and combining them as basic XaaS services in C/M layer 320.

Define C/M Plane of the 6G system which includes C/M functions in XaaS services and may include 5G control plane (e.g., an authentication management function (AMF)) depending on implementation options.

Define Basic Architecture Structure (BAS) which is a unified basic structure with minimized number of interfaces and is independent of types of infrastructures.

Simplify standardization, development and deployment of the 6G system using the BAS concept, while supporting a variety of infrastructure deployment scenarios.

Adapt to a variety of deployment scenarios by applying the BAS or a subset of it to infrastructures based on capability, capacity and requirement of the infrastructure networks.

Leverage service-based interface (SBI) concept and apply SBI interaction in both 6G C/M plane and 6G data plane.

Simplify SBI interfaces by introducing trustworthy (TW) gateways (GWs) in data plane and C/M plane of the 6G system.

Improve trustworthiness from perspectives of operation of the 6G system by introducing CONET capability, NET4BC capability and anonymous service provisioning provided by the trustworthy GWs in the C/M plane and data plane of the 6G system.

Improve trustworthiness from perspective of end customer privacy protection by unified mutual authentication, IDM, data sanitization and etc. provided by SPM 323 service, DAM 313 service, and 6G block chain service.

Simplify roaming management of wireless devices, in physical world and digital world, by unified authentication including all participated partners and customers.

Support multiple development paths from 5G system to 6G system by defining multiple architecture options without incurring much efforts due to the introduction of the BAS concept.

Support backward compatibility by utilizing benefits of SBA and its add-on feature. 5G users can use the 6G system to access 5G services.

Support future extension by adding new XaaS services with minimized impact on standardization and deployment, due to the introduced anonymous service provisioning concept implemented in trustworthy GWs in 6G C/M plane and in 6G data plane.

Under the scope of increasing societal digitization, a universal and ultra-high-performance Information and Communication Technology (ICT) infrastructure is considered as an important foundation to support demands from individual users, as well as from so-called vertical industries. 3G networks attempted to capture the Internet market by providing certain services, but limited these to the technological domain of telecommunication operators, hence largely failing to attract the Internet players. 4G networks corrected this through an efficient implementation of high-speed IP packet delivery, opening up the service space. 5G networks provided a successful beginning for integrating new types of network usage and new user communities, and provided a beginning for industry use cases and players. The philosophy underlying 5G development might be roughly summarized through connecting more and different types of users better. However, for the users, service-level properties are important and 5G as a connecting network or access network cannot fully control these. This identifies a gap between the aspirations of 5G and the actual technical specification.

The 6G network might be characterized by a high degree of heterogeneity in terms of participating players, which includes not only conventional telecommunications operators, but also new relevant players such as vertical operators. Ecosystem Openness of future networks is relevant from technology aspect as well as from social and commercial aspects. Furthermore, a trustworthy and secure interactions among the players should be provided in the multi-player ecosystem, and the data flowing and usage among the players raises the concern on security and privacy protection. The 6G network should have native support for privacy protection.

Future networks may also be expected to play more and more important role in future society and become an attractive industry. A more open business environment and ecosystem regarding development, deployment, operation, control and management of wireless network can be expected. A variety of players in this industry will play different roles. Exclusively control and management of wireless networks by operators is facing huge challenges. Embodiments of the present disclosure may provide or support CONET which may provide confederation services for multiple parties (players) to address these challenges effectively.

Embodiments of the present disclosure provide methods, apparatuses, computer readable storage medium, computer program product for managing a chain for multiple players. In the present solution, an XaaS entity may request for uploading data to the blockchain by sending a first request to a first function, such as a confederation control function (CCF), and accordingly, the CCF may trigger setting up a chain on the blockchain and notify to the XaaS entity of information about the chain. In the present solution, the XaaS entity may upload its data to the chain according to a first response from the CCF. As such, the CCF may control and manage an uploading operation of an XaaS entity, thus, a chain related procedure may be enabled for multiple players and a credible solution may be guaranteed. Therefore, the system can be scalable and credible for multiple players to work together. Principles and implementations of the present disclosure will be described in detail below with reference to the figures.

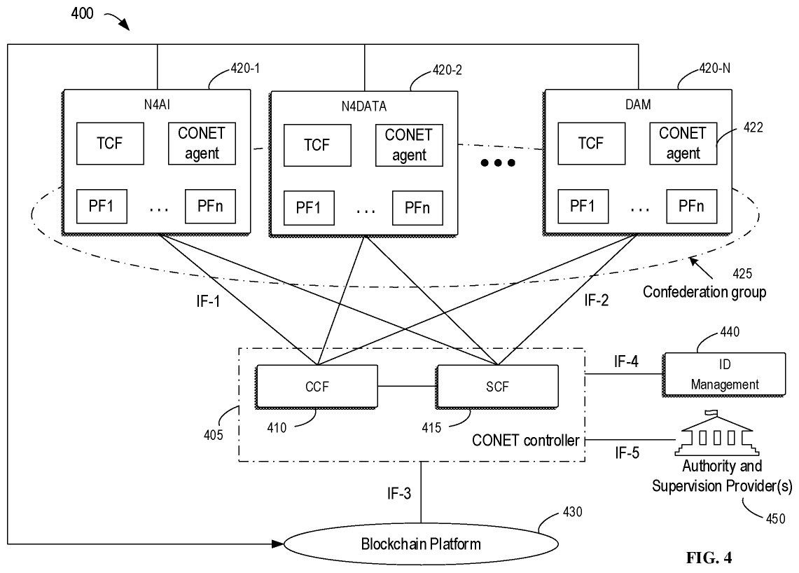

FIG. 4 illustrates an example CONET architecture 400 in which some example embodiments of the present disclosure may be implemented. As shown in FIG. 4, multiple service modules 420-1 through 420-N (generically referred to as modules 420) which may form a confederation group 425. As illustrated in FIG. 4 the CONET architecture 400 includes a CONET controller 405 and one or more CONET agents 422. The CONET controller 405 includes a confederation control function (CCF) 410 and a surveillance control function (SCF) 415. The CCF 410 and the SCF 415 may be operatively coupled together and may be implemented using the same or different networked computing hardware, such as servers, dedicated electronics, virtualized computing resources, etc. The one or more CONET agents 420 are similarly operatively coupled to the SCF 415 and may be implemented using networked computing hardware, for example hardware which is integrated with or operatively coupled to the 420 modules 420 within which the agents 422 are respectively integrated.

By way of non-limiting example, the modules 420 may include a network for artificial intelligence (N4AI) module 420-1, a network for data (N4DATA) module 420-2, . . . , and a data analytics and management (DAM) module 420-N. These examples are not necessarily intended to be limiting.

Each of the modules 420 may provide a different respective role in the service. This role may be provided as a sub-service in accordance with the XaaS model. Each of the modules 420 may include a task control function (TCF) for managing provision of the sub-service and a plurality of processing functions (PFs) for provision of the sub-service. An entity (e.g. a PF) as used herein may refer to an instantiation of a module or function. For example, a DAM02 entity may be an instantiation of a DAM module 420-N. At an operation stage, an entity generates transactions and uploads action records to a blockchain, e.g. via NET4BC.

At a development or deployment stage, the modules 420 operate together as partners to join the confederation group 425 and provide a confederation chain profile. A confederation chain profile, in the context of the modules 420 and also more generally, may specify information such as a module topology and performance requirements in relation to a blockchain.

Accordingly, in various embodiments, a system in a computer network is provided. The system includes a plurality of network functions established using networked computing resources and operatively coupled together. These network functions include the CCF 410, the SCF 415, and the agents 422. The CCF 410 is configured to establish and manage a confederation involving a plurality of modules 420. The confederation may provide a service via cooperation of the modules 420. The agents 422 are each integrated into a different respective one of the plurality of modules 420. Each agent 422 may be configured to generate and provide (e.g. to the SCF 415) a record of actions taken by said respective one of the plurality of modules 420. The SCF 415 is configured to deploy and communicate with the agents 422. The SCF 415 is also configured to perform surveillance of actions taken by the modules 420, for example based at least in part on the records of actions provided by the agents 422. Agents 422 may operate as interface between their host module 420, within which they are deployed, and the controller 405. At an operation stage, the agents 422 are configured to collect action records of their host modules 420 and send surveillance reports to the controller 405.

The controller 405 may include a shared C/M layer to support XaaS services working together in a trusted environment. At a development/deployment stage the controller 405 facilitates modules 420 to join the confederation group 425, and notifies the blockchain (e.g. at NET4BC) with profile information to initialize a corresponding blockchain. At an operation stage, the controller 405 receives upload/surveillance action of upload/data update requests from entities (modules) and notifies the blockchain.

In more detail, the CCF 410 may be configured to perform operations such as: establishing the confederation, allowing modules to leave or join the confederation, retrieving a confederation profile, triggering uploads to blockchain, managing authentication and/or authorization of modules, and interacting with control plane gateways. A group profile of a confederation group 425 may indicate, for example a group ID and a member ID for the confederation group 425. This may involve message passing between the CCF 410 and the modules 420, the CCF 410 retrieving information from the modules 420 and sending queries or commands to the modules 420, performing logging, authentication and verification steps, and the like.

Also in more detail, the SCF 415 may be configured to perform operations such as: deploying (e.g. instantiating and configuring) and managing the agents 422, performing surveillance (e.g. monitoring and logging) of the modules 420, and supporting lawful queries, such as requests for information made by authorities or regulatory agencies.

The CCF 410 interacts with the modules 420 via a network interface indicated as IF-1. The SCF 415 interacts with the modules 420, agents 422, or both, via a network interface IF-2. The CCF 410 interacts with a blockchain platform 430 via a network interface IF-3. For example, the CCF 410 may interact via IF-3 with the blockchain platform 430 in order to trigger the platform to provide services, for example by establishing a blockchain according to a confederation group request, and triggering the blockchain to perform logging operations, action uploads, etc. The CCF 410 may thus direct a blockchain platform 430 (also referred to as a blockchain service) to establish a blockchain to support the service, and to direct the modules 420 to utilize the blockchain for providing the service. Subsequent utilizing of the blockchain by the modules 420 may include posting log records to the blockchain, posting action requests to the blockchain, or the like, or a combination thereof. At a deployment stage, the blockchain platform 430 (e.g. NET4BC) initializes a blockchain according to a given chain profile. At an operation stage, the blockchain platform 430 receives information such as transmission uploads or surveillance actions, generates blocks, verifies blocks and stores blocks. The blocks may be stored using NET4Data, for example.

The CCF 410 interacts with an ID management entity 440 via a network interface IF-4. The ID management entity 440 may be an authorization and authentication server, for example, which authenticates devices for example via cryptographic certificates, and provides authorization services, as would be readily understood by a worker skilled in the art. The interaction via IF-4 may support the CCF's action of authentication and/or authorization of the modules 420. Thus, the CCF 410 may be configured to perform or trigger authentication and/or authorization of each of the modules 420, in cooperation with the ID management entity 440, and to admit each of the modules 420 to the confederation group 425 only after successful completion of said authentication and/or authorization.

The SCF 415 may interact with one or more authority and supervision providers (ASPs) 450 via IF-5. The ASPs 450 may be or represent legal authorities, regulatory agencies, or the like. The ASPs 450 may monitor activities of the modules 420 or end users via reports from the SCF 415. The ASPs 450 may be required to comply with certain regulations or laws prior to such monitoring. Thus, the SCF 415 may be configured to receive and respond to queries from government or regulatory authority agencies, at least in part by providing information obtained by the SCF 415 to said government or regulatory authority agencies, upon determining that it is lawful to do so.

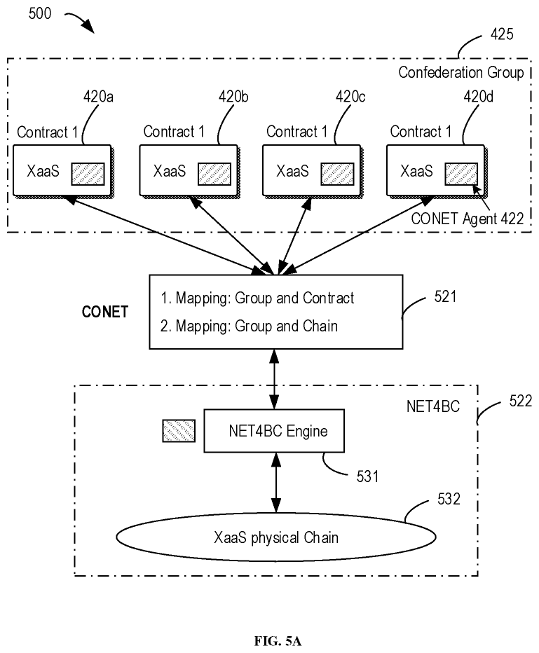

FIG. 5A illustrates an example framework 500 of elements related to CONET in accordance with some example embodiments of the present disclosure. The framework 500 illustrates a CONET at XaaS level design. Multiple service modules 420a, 420b, 420c, 420d (generically referred to as 420), each provides an XaaS service, may form a confederation group 425. In addition, each of the multiple service modules 420 may include a CONET agent, such as the CONET agent 422 as shown in FIG. 5A.

The CONET controller 405 as shown in FIG. 4 may include a CONET module 521 which operates at the XaaS level and a NETBC engine 531 which operates at the NETBC level. The blockchain platform 430 as shown in FIG. 4 may include an XaaS physical chain 532.

The CONET module 521 may provide its functionality as a service to other Xaas modules, such as but not necessarily limited to the multiple service modules 420a-420d. In such a scenario, the CONET module 521 operates at the XaaS level. Each player registers to the CONET module 521, and the CONET module 521 performs mapping of a group and a contract and mapping of a group and a chain. After these procedures, players (e.g. the above-mentioned modules) work together in the same group or confederation to perform defined actions.

The NET4BC module 522 may provide a NETBC service. As shown in FIG. 5A, the NET4BC module 522 includes a NET4BC engine 531 and an XaaS physical chain 532. The NETBC engine 531 provides generic management and control of block chain operations. The NET4BC engine 531 handles block data and enables block chain as a service. The NET4BC engine 531 may be configured to initialize blockchains, generate blockchain blocks (records), verify blockchain blocks, and store blockchain blocks on the XaaS physical chain 532. Blockchain operation can proceed in a variety of ways as will be readily understood by a worker skilled in the art, to provide a (e.g. public) record of transactions, actions or events.

In FIG. 5B, a framework 550 of main elements related to CONET include an XaaS service 551, a group 561, a contract 571 (also refer to a group contract), and a chain 581. In some embodiments, each XaaS service, such as DAM, NET4AI, or NET4DATA, works as a member to join a group and requests requirement to the CONET module 521. The CONET module 521 aggregates different XaaS services into a same group.

In the present disclosure, a group may be called as a confederation group, a CONET group, etc., and a group includes multiple XaaS services. Each XaaS service in a group may be called as an XaaS service consumer, and may be regarded as a member or a player of a group, in other words, a group may include multiple members or multiple players.

A group is associated with a contract that defines the role and behaviors of each of the different XaaS services. Different groups may correspond to different contracts. A group may consist of the minimum number of XaaS services that can implement functions to reduce redundancy. The CONET module 521 employs blockchain to ensure trustworthiness for each XaaS service in a group. The CONET module 521 performs the mapping operation between group and blockchain according to requirement from XaaS services and are on blockchain. The NET4BC engine 531 receives requirement and initials a blockchain for a group.

In some embodiments, an XaaS service is identified by an XaaS service ID and a group is identified by a group ID. Multiple XaaS service IDs may be associated with one group ID, since multiple XaaS services (the quantity may be N, as shown in FIG. 5B, the value of N is greater than 1.) form a group. A group contract is identified by a contract ID and a contract defines the role and behaviors of each member in the corresponding group. Therefore, a group ID corresponds to a contract ID.

An XaaS service may be described using an XaaS service profile, e.g., profile information of the XaaS service. The XaaS service profile (profile information of the XaaS service) may include one or more of: a service name of the XaaS service, a service ID of the XaaS service, one or more entity names of one or more entities which the XaaS service comprises, one or more entity IDs of the one or more entities, entity information of the one or more entities (including one or more entity locations of the one or more entities), deployment information associated with at least one valid entity in the one or more entities, role information of each of the one or more entities, an action list for each of the one or more entities, or a requirement of the XaaS service. In some embodiments, details of the XaaS service profile (profile information of the XaaS service) may refer to Table 1 below.

TABLE 1
XaaS service profile

| Name | Description |
|---|---|
| XaaS service name | This information indicates the name of XaaS service. |
| XaaS service ID | This information identifies the XaaS service. |
| Entity name | This information indicates the name of the entity. |
| Entity ID | This information identifies the entity contained in the XaaS |
| | service. |
| Entity location | This information indicates where the entity is valid. |
| Deployment profile | This information describes where each entity is valid to indicate |
| | C/M-TW-GW and MM to generate BAS topology profile and MM |
| | policy table respectively. |
| Role profile | This information describes the roles of each entity to indicate |
| | C/M-TW-GW to generate authorization profile and MM policy |
| | table respectively. |
| Action list profile | This information describes the action list of each entity. |
| Requirement from XaaS | This information describes the service requirements of XaaS for |
| service | CONET. |

In some examples, the XaaS service name may indicate the name of XaaS service, such as NET4AI, DAM, NET4DATA, or NET4BC. In some examples, the XaaS service ID may be used to identify the XaaS service, e.g., the XaaS service ID may be NET4AI ID, DAM ID, NET4DATA ID, or NET4BC ID. In some embodiments, an XaaS service may include one or more entities, for example, the NET4AI includes entities of AI encoder, AI classifier, and AI evaluator. In some examples, the entity name may include one or more entity names of the one or more entities. In some examples, the entity ID may be used to identify the entity(ies) included in the XaaS service. For example, if the XaaS service name is NET4AI, the entity ID may include AI encoder ID, AI classifier ID, and AI evaluator ID. In some examples, the entity location may indicate where the entity/entities is/are valid (e.g. deployed), for example, the CONET module 521 may choose suitable entity (or entities) based on the entity location. In some examples, the deployment profile may be used to describe where each entity is valid to indicate to C/M-TW-GW and MM to generate a BAS topology profile and MM policy table respectively. In some examples, the role profile may be used to describe the roles of each entity to indicate to C/M-TW-GW to generate authorization profile and MM policy table respectively. In some examples, the action list profile may be used to describe the action list of each entity. In some examples, the requirement from XaaS service may be used to describe the service requirements of XaaS for CONET. For example, if the XaaS service name is DAM, the requirement from XaaS service may indicate throughput and delay of DAM proceeding for CONET. In some instances, the requirement from XaaS service in the XaaS service profile may be replaced by XaaS request service, and the present disclosure does not limit.

A group may be described using a group profile, e.g., group information. The group information (group profile) may include one or more of: a group name, a group ID, a list of members which the group comprises, or a list of member IDs of the members. In some embodiments, details of the group profile (group information) may refer to Table 2 below.

TABLE 2
group profile

| Name | Description |
|---|---|
| Group name | This information indicates the name of group. |
| Group ID | This information identifies the group. |
| Group member | This information describes each member in a group. |
| Group member ID | This information identifies the group member. |

In some examples, the group name may indicate the name of the group, for example, the naming may show a purpose of the group. In some examples, the group ID may be used to identify the group, for example, each member in the group may have (or be associated with, correspond with) the group ID. For example, multiple members in the group may share the same group ID. In some examples, the group member may be used to describe each member in the group. In some examples, the group member ID may be used to identify the member(s) in the group. For example, if the group includes an XaaS service, then the group member ID may include (or be the same as) the XaaS service ID of the XaaS service. For example, if the group includes an entity, then the group member ID may include (or be the same as) the entity ID of the entity.

A contract (or group contract) may be described using a contract profile, e.g., contract information. The contract information (contract profile) may include one or more of: a contract name, a contract ID, or contract content. In some embodiments, details of the contract profile (contract information) may refer to Table 3 below.

TABLE 3
contract profile

| Name | Description |
|---|---|
| Contract name | This information indicates the name of contract. |
| Contract ID | This information identifies the contract. |
| Contract | This information describes the content of contract, i.e. |
| content | the rules for each member to follow in a group. |

In some examples, the contract name may indicate the name of the contract, for example, the naming rule for the contract may follow the name of the group, e.g. a purpose of the group. For example, a group for charging may correspond to a contract, and the contract may be named as “charging”. In some examples, the contract ID may be used to identify the contract, and it is understood that a contract ID corresponds to a group ID. In some examples, the contract content may be used to describe the content of the contract, for example, the content may indicate rules for each member in the group to follow.

A chain may be described using a chain profile, e.g., chain information. The chain profile (chain information) may include one or more of: a chain name, a chain ID, a list of blockchain requirements, a list of blockchain performances, or a list of upload methods. In some embodiments, details of the chain profile (chain information) may refer to Table 4 below.

TABLE 4
chain profile

| Name | Description |
|---|---|
| Chain | This information indicates the name of blockchain. |
| name | |
| Chain ID | This information identifies the blockchain. |
| Chain | This information describes blockchain requirement from the |
| requirement | entity to NET4BC, i.e. topology, data type, security level, |
| | performance requirement. |
| Chain | This information describes blockchain performance |
| performance | feedbacked by NET4BC. |
| Upload | This information indicates to entity methods to upload to |
| methods | blockchain, i.e., the full content, the abstract of the content, |
| | and the URL of blockchain. |

In some examples, the chain name may indicate the name of blockchain. Each entity has its own action(s). For example, an entity DAM has actions of Data collection, Data pre-processing and Data sanitization, while another entity NET4AI has actions of AI encoder, AI classifier and AI evaluator. In some examples, the chain ID may be used to identify the blockchain, each chain ID may correspond to one group ID. In some examples, the chain requirement may be used to describe blockchain requirement(s) from the entity to NET4BC. For example, a topology (examples of which may include distributed (“Dis.” in Table 5) or centralized (“Cen.” in Table 5)) indicates the structure and type of the blockchain, a security level indicates the read/write permission, and a performance requirement (also refers to a performance request or a requirement) indicates throughput and delay of the blockchain. In some examples, the upload methods may be used to indicate to entity methods to upload to the blockchain, i.e. the full content, the abstract of the content, and a uniform resource locator (URL) of the blockchain. In other words, the upload methods may provide methods for entities uploading to the blockchain.

As mentioned above with reference to FIG. 5A, the CONET module 521 may perform a mapping operation, e.g., between a group and a contract, between a group and a chain, where the group may include multiple XaaS services (members). In some embodiments, the mapping among XaaS services, group, and contract may be described by service management information, e.g., represented by a service management table. In some embodiments, the mapping among XaaS services, group, contract, and chain may be described by chain management information, e.g. represented by a chain management table.

Take a group with a group ID “G001” as an example, for example, the group may have a group name of “AI training.” Assume that the group includes DAM (service ID S00101), NET4AI (service ID S00102), and NET4DATA (service ID S00103) as members. The group may have a contract with a contract with a contract ID “C00020” and may correspond to a chain with a chain ID “BC012”. Details of the chain management table for the group “AI training” may refer to Table 5 below.

TABLE 5
chain management table

| Service | Service | Group | Contract | Chain | Entity | | Data | Security | Performance | Chain | Upload |
|---|---|---|---|---|---|---|---|---|---|---|---|
| name | ID | ID | ID | ID | ID | Topology | type | level | request | performance | method |
| DAM | S00101 | G001 | C00020 | BC012 | DAM001 | Dis., | Network | High | Throughput | 10MTPS, | Abstract |
| | | | | | | Cen. | data, | | and delay | 10 ms | |
| | | | | | | | sensing | | # the | | |
| | | | | | | | data, | | number of | | |
| | | | | | | | IoT | | data | | |
| | | | | | | | data | | source | | |
| DAM | S00101 | G001 | C00020 | BC012 | DAM001 | Cen. | Action | High | Throughput | 50MTPS, | Abstract |
| | | | | | | | record | | and delay | 20 ms | |
| | | | | | | | | | # de- | | |
| | | | | | | | | | privatized | | |
| | | | | | | | | | data | | |
| | | | | | | | | | amount | | |
| NET4AI | S00102 | G001 | C00020 | BC012 | NET4AI001 | Cen. | Action | High | Throughput | 20MTPS | URL |
| | | | | | | | record | | # incoming | | |
| | | | | | | | | | data rate | | |
| NET4AI | S00102 | G001 | C00020 | BC012 | NET4AI002 | Cen. | Action | High | Throughput | 10MTPS | URL |
| | | | | | | | record | | # incoming | | |
| | | | | | | | | | data rate | | |
| NET4DATA | S00103 | G001 | C00020 | BC012 | NET4DATA002 | Dis. | Stored | High | Throughput | 10MTPS | Content |
| | | | | | | | data | | Read-only | | |
| | | | | | | | | | permission | | |
| NET4DATA | S00103 | G001 | C00020 | BC012 | NET4DATA005 | Dis. | Message | Low | Throughput | 1MTPS, | Content |
| | | | | | | | | | and delay | 10 ms | |
| | | | | | | | | | # the | | |
| | | | | | | | | | amount of | | |
| | | | | | | | | | messages | | |

The chain management table may manage mapping between group and chain, the fields (columns) in the chain management table shown in Table 5 are some non-limited examples. In some embodiments, the chain management table in Table 5 is only for illustration without any limitations. In some examples, more columns may be further included, such as group name, contract name, chain name, group member, contract content, etc. In some examples, one or more columns may be omitted, such as contract ID. Details of each column in the chain management table may refer to that discussed above with reference to Tables 1-4.

It is to be understood that the format of the chain management table in Table 5 is only for illustration without any limitation, for example, the column and the row can be interchanged, for example, a column may be associated with the data of the XaaS entity, details of which will not be repeated.

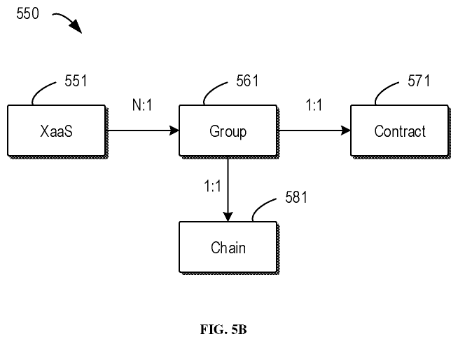

FIG. 6 illustrates a group setup process 600 in accordance with some embodiments of the present disclosure. The process 600 involves an XaaS service module 420 and a CONET service module 601, where the XaaS service module 420 may provide an XaaS service. In some embodiments, the XaaS service module 420 may include a network function 602, the CONET service module 601 includes a CCF 410, and the process 600 may involve the network function 602 and the CCF 410. For example, the network function 602 may be a TCF or a PF of the XaaS service module 420. The CCF 410 can be referred as a first function, and the network function 602 can be referred as a second function.

In the process 600, the XaaS service module 420 (e.g. the network function 602) transmits a group join request to the CONET service module 601 (e.g. the CCF 410) at 610. In some embodiments, when the XaaS service needs to join in a certain group, the XaaS service (for example, the network function 602 associated with the XaaS service) may transmit the group join request for joining in the certain group. In some examples, the group join request may be implemented as a suitable message or signalling, for example, the group join request may be Nconet.ccf_Management_XaaSJoinGroup_request.

In the process 600, the CONET service module 601 (e.g. the CCF 410) verifies identity information of the XaaS service, to determine whether to accept the group join request, at 620. For example, an identity of the XaaS service may be verified. For example, the CCF 410 may determine to accept the group join request.

In the process 600, the CONET service module 601 (e.g. the CCF 410) transmits a profile request to the XaaS service module 420 (e.g. the network function 602) at 632. In some embodiments, the profile request is used for asking for profile information of the XaaS service. In some examples, the profile request may be implemented as a suitable message or signalling, for example, the profile request may be Nconet.ccf_Management_XaaSProfileInfo_request.

In response to the profile request, the XaaS service module 420 (e.g. the network function 602) transmits a profile response to the CONET service module 601 (e.g. the CCF 410) at 634. In some embodiments, the profile response may include profile information of the XaaS service. For example, the profile information may include XaaS service ID, deployment profile, role profile, etc., which may refer to Table 1 discussed above. In some examples, the profile response may be implemented as a suitable message or signalling, for example, the profile response may be Nconet.ccf_Management_XaaSProfileInfo_response. In other words, the XaaS service module 420 (e.g. the network function 602) sends Nconet.ccf_Management_XaaSProfileInfo_response message to the CCF 410 with XaaS member ID, deployment profile, and role profile described in the XaaS service profile.

In addition, the CONET service module 601 (e.g. the CCF 410) sets up a group at 640. In some embodiments, the CCF 410 may use the profile information obtained at 634 to set up (or update if the group exists) a group. In some examples, the CCF 410 may record multiple members in the group, where the multiple members include the XaaS service associated with the group join request. For example, the XaaS service ID of the XaaS service may be regarded as a member ID. In other words, the CCF 410 uses the deployment profile and role profile to setup a CONET group and records members in this group.

The CONET service module 601 (e.g. the CCF 410) transmits a group establish notification to the XaaS service module 420 (e.g. the network function 602) at 652. In some embodiments, the group establish notification may be transmitted to each member in the group. As such, the CCF 410 may notify each member in the group of the group establishment. In some examples, the group establish notification may be implemented as a suitable message or signalling, for example, the group establish notification may be Nconet.ccf_Management_GroupEstablish_notification. In other words, the CCF 410 notifies each member in this group to confirm group establishment with message Nconet.ccf_Management_GroupEstablish_notification.

In response to the group establish notification, the XaaS service module 420 (e.g. the network function 602) transmits a group establish response to the CONET service module 601 (e.g. the CCF 410) at 654. In some embodiments, each member in the group may confirm the group establishment by a corresponding group establish response. In some examples, the group establish response may be implemented as a suitable message or signalling, for example, the group establish response may be Nconet.ccf_Management_GroupEstablish_response. In other words, each XaaS service in this group sends Nconet.ccf_Management_GroupEstablish_response message to confirm group establishment.

The CONET service module 601 (e.g. the CCF 410) further updates the group profile at 660. In some examples, the group profile may refer to Table 2 discussed above. The CONET service module 601 (e.g. the CCF 410) maps the group to a contract at 670. Specifically, the CCF 410 may generate a contract with contract information, and may further map the contract to the group.

The CONET service module 601 (e.g. the CCF 410) transmits a group information notification to the XaaS service module 420 (e.g. the network function 602) at 682. In some example embodiments, the group information notification may include the group information (group profile) and the contract information (contract profile). For example, the group information notification may include a group ID, a contract ID, contract content, etc. as described with reference to Tables 2-3. In other words, the CCF 410 sends Nconet.ccf_Management_GroupInfo_notification message with member ID, group ID, contract ID, and contract content.

In some embodiments, the group information notification may be transmitted to each member in the group. As such, the CCF 410 may notify each member of the group information and the contract information. In some examples, the group information notification may be implemented as a suitable message or signalling, for example, the group information notification may be Nconet.ccf_Management_GroupInfo_notification.

In response to the group information notification, the XaaS service module 420 (e.g. the network function 602) transmits a group information response to the CONET service module 601 (e.g. the CCF 410) at 684. In some embodiments, each member in the group may confirm the group information notification. In some example embodiments, the group information notification may include profile information of the XaaS service, for example, the group information notification may include a member ID, action list profile, etc. as described with reference to Table 1. In other words, the XaaS service (for example the network function 602 associated with the XaaS service) receives Nconet.ccf_Management_GroupInfo_notification message and sends Nconet.ccf_Management_GroupInfo_response to the CCF 410 with member ID, group ID and action list profile described in the XaaS service profile.

In some examples, the group information response may be implemented as a suitable message or signalling, for example, the group information response may be Nconet.ccf_Management_GroupInfo_response.

In the process 600, the CONET service module 601 (e.g. the CCF 410) updates the service management table at 690. In some embodiments, the CCF 410 receives the group information response and may further obtain information in the group information response, in addition, the CCF 410 may update the service management table based on the information in the group information response. For example, the group information notification may include action list profile, and the action list profile may be used for updating the service management table. In other words, the CCF 410 receives Nconet.ccf_Management_GroupInfo_response message and updates the action list profile.

According to some embodiments with reference to FIG. 6, a group may be set up by the CCF based on a group join request from an XaaS service, and accordingly, the CCF 410 may control and manage the group which includes at least the XaaS service.

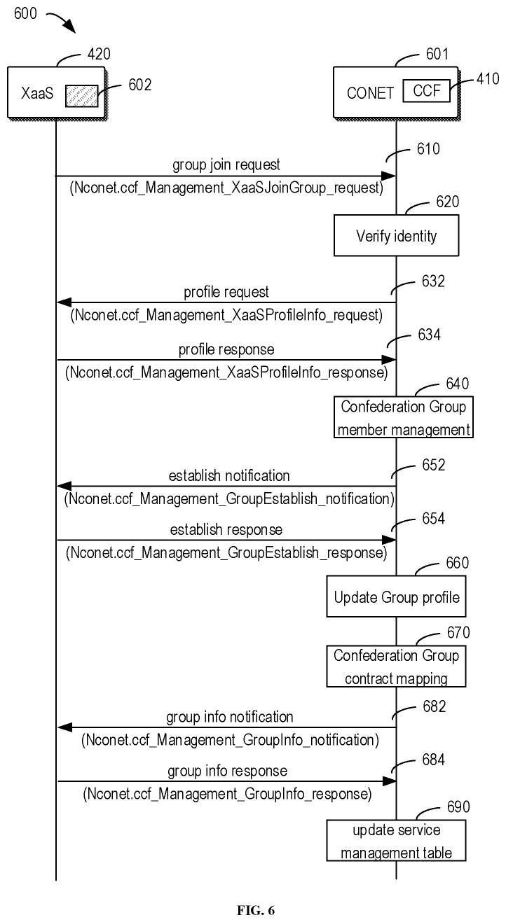

FIG. 7 illustrates an example process 700 for uploading to a chain in accordance with some embodiments of the present disclosure. The process 700 involves an XaaS service module 420 and a CONET service module 601, where the XaaS service module 420 may provide an XaaS service. In some embodiments, the XaaS service module 420 may include a network function 602, the CONET service module 601 includes a CCF 410, and the process 700 may involve the network function 602 and the CCF 410. For example, the network function 602 may be a TCF or a PF of the XaaS service module 420. The CCF 410 can be referred as a first function, and the network function 602 can be referred as a second function.

In the process 700, the XaaS service module 420 (e.g. the network function 602) transmits a first request to the CONET service module 601 (e.g. the CCF 410) at 710. In some implementations, the first request may be used for uploading data of an XaaS entity of the XaaS service to a blockchain. In some embodiments, when the XaaS service needs to upload its data to a chain, it may transmit the first request. In some examples, the first request may be implemented as a suitable message or signalling, for example, the first request may be Nconet.ccf_Management_UploadToChain_request.

The data to be uploaded may be called as “data of the XaaS entity” in the present disclosure, which include data generated by the XaaS entity of the XaaS service and/or data associated with the XaaS entity. For example, the data of the XaaS entity may include some or all of the following: network data, sensing data, IoT data, message, action record data, etc. For example, the action record data may refer to an action log.

Optionally, the CONET service module 601 (e.g. the CCF 410) may perform a verification of identity information of the XaaS entity in response to receiving the first request. For example, the CONET service module 601 (e.g. the CCF 410) may determine to accept the first request by performing a verification. As such, in case the XaaS entity is not trustworthy, the first request may be rejected (i.e. not accepted) by the CCF 410, that is, only trustworthy XaaS entity may request for uploading, therefore, a safety can be guaranteed. In the present disclosure, it is assumed that the CCF 410 verifies the identity of the XaaS entity and decides to accept the first request.

Alternatively, the CONET service module 601 (e.g. the CCF 410) may transmit a third request to the XaaS service module 420 (e.g. the network function 602), where the third request may be used for requesting data information of the XaaS entity. Accordingly, in response to the third request, the XaaS service module 420 (e.g. the network function 602) may transmit a third response to the third request, and the third response may include the data information of the XaaS entity. For example, the data information may include chain requirement of the data of the XaaS services. For example, the data information in the third response may include some or all of the following: topology, data type, security level, performance request, etc.

In some examples, the third request and third response may be implemented as suitable messages or signalling, for example, the third request may be Nconet.ccf_Management_ChainInfo_request, and the third response may be Nconet.ccf_Management_ChainInfo_response.

As such, chain information of the XaaS entity may be obtained by the CCF 410 through the third request, and accordingly a chain setup procedure may be enabled. For example, an entry associated with the XaaS entity may be added in a chain management table, and some fields of the entry may be filled based on the third response.

In the process 700, the CONET service module 601 (e.g. the CCF 410) triggers setting up a chain on the blockchain based on the first request at 720. In some implementations, for setting up the chain, the CONET service module 601 (e.g. the CCF 410) would like to determine (or generate) chain management information of the chain which may include multiple entries. In some embodiments, an example of the chain management information may refer to the chain management table shown at Table 5 above, and an entry may be referred to as a row in the chain management table. For example, an entry may be associated with the data of the XaaS entity.

In some embodiments, the chain management information may be determined (or generated) based on service profile, group profile, contract profile, and chain profile. In some implementations, for determining the chain management information of the chain (or for setting up the chain), the CONET service module 601 (e.g. the CCF 410) would like to generate a chain profile of the chain, which includes chain name, chain ID, chain requirement, chain performance, and upload methods as shown in Table 4. In some examples, the CONET service module 601 (e.g. the CCF 410) may obtain the service profile. In some examples, the CONET service module 601 (e.g. the CCF 410) may generate group profile, contract profile, and chain profile. For the chain profile, the CONET service module 601 (e.g. the CCF 410) can acquire the chain requirement, e.g., from the third response discussed above; and the CONET service module 601 (e.g. the CCF 410) needs to acquire other information for the chain profile.

In some embodiments, the CONET service module 601 (e.g. the CCF 410) may transmit a second request to an engine of the blockchain, where the second request may request setting up the chain. In some examples, the second request may include data information, e.g. that included in the third response. In some examples, the second request may include the chain profile of the chain, i.e. the chain requirement of the data. Accordingly, the engine of the blockchain may set up the chain on the blockchain based on the second request. In addition, the engine of the blockchain may transmit a second response to the CONET service module 601 (e.g. the CCF 410), and the second response may indicate that the chain has been set up on the blockchain, where the second response includes a chain performance of the chain. In some examples, the second response may include location information of the chain on the blockchain, such as a URL.

In some instances, the chain name and/or the chain ID may be determined (or generated) by the CONET service module 601 (e.g. the CCF 410). For ease of description, it is assumed that the chain set up based on the first request is with a chain name “Chain-Name1” and a chain ID. In some examples, the second request may include the chain name and/or the chain ID. In addition, the second response may include the chain name and/or the chain ID, so that the chain performance included in the second response may be determined to associate with the chain name and/or the chain ID. Optionally, the second request further include one or more of the following: a group ID, a contract ID, member IDs in the group corresponding to the chain, etc. Optionally, the second response may further include one or more of the following: a group ID, a contract ID, member IDs in the group corresponding to the chain, etc.

In some other instances, the chain name and/or the chain ID may be determined (or generated) by the engine of the blockchain. In some examples, the second request may include a group name and/or a group ID. In addition, the second response may include the chain name and/or the chain ID which has a one-to-one correspondence with the group name and/or the group ID. In some examples, the second response may further include the group name and/or the group ID, so that the chain name and/or the chain ID, and the chain performance included in the second response may be determined to associate with the group name and/or the group ID. Optionally, the second request further include one or more of the following: a contract ID, member IDs in the group corresponding to the chain, etc. Optionally, the second response may further include one or more of the following: a contract ID, member IDs in the group corresponding to the chain, etc.

In some examples, the second request and second response may be implemented as suitable messages or signalling, for example, the third request may be Nconet.ccf_Management_SetUpChain_request, and the third response may be Nconet.ccf_Management_SetUpChain_response.

As such, the chain on the blockchain for uploading data may be set up by NET4BC responsive to the second request from the CCF, the CCF then may obtain location information where the data may be uploaded to, and the location information may be used by the CCF to generate a first response to the first request.

Additionally or alternatively, the CONET service module 601 (e.g. the CCF 410) may determine (or generate, or update) the chain profile. For example, the information included in the second response (such as the chain performance) may be added into the chain profile.

Additionally or alternatively, the CONET service module 601 (e.g. the CCF 410) may determine (or generate, or update) the chain management information (e.g. the chain management table) based on the second response from the engine of the blockchain. For example, the CONET service module 601 (e.g. the CCF 410) may determine an upload method for the data of the XaaS entity. For example, the information included in the second response (such as the chain performance) may be added in the chain management information of the chain. For example, the upload method for the data of the XaaS entity may be added in the entry associated with the data of the XaaS entity in the chain management information of the chain.

As such, the chain management information maintained by the CCF may be updated in time and may be used for controlling or managing the chain. For example, an entry associated with the XaaS entity, which has been added in a chain management table with some fields filled based on the third response as discussed above, may be further updated, e.g. some other fields may be filled based on the second response.

In the process 700, the CONET service module 601 (e.g. the CCF 410) transmits a first response to the XaaS service module 420 (e.g. the network function 602) at 730. In some examples, the first response may include the chain name and/or the chain ID of the chain. In some examples, the first response may include location information (e.g. a chain URL) of the chain on the blockchain. In some examples, the first response may include an upload method for uploading. It should be understood that less or more information may be included in the first response, and the present disclosure does not limit.

In some examples, the first response may be implemented as a suitable message or signalling, for example, the first response may be Nconet.ccf_Management_UploadToChain_response.

In addition, the XaaS service module 420 (e.g. the network function 602) uploads the data to the chain on the blockchain at 740. Specifically, the data may be uploaded to the URL which is indicated by the first response.

In some embodiments, if the first response includes an upload method, the XaaS service module 420 (e.g. the network function 602) may process the data based on the upload method and uploaded processed data to the chain. For example, the upload method may be “abstract”, then an abstract of the data may be uploaded. For example, the upload method may be “URL”, then a URL of the data may be uploaded. For example, the upload method may be “content”, then a full text of the data may be uploaded.

Therefore, a procedure for uploading data to the blockchain is enabled which is initiated by a first request from the XaaS entity, and the uploading procedure can be controlled and managed by the CCF.

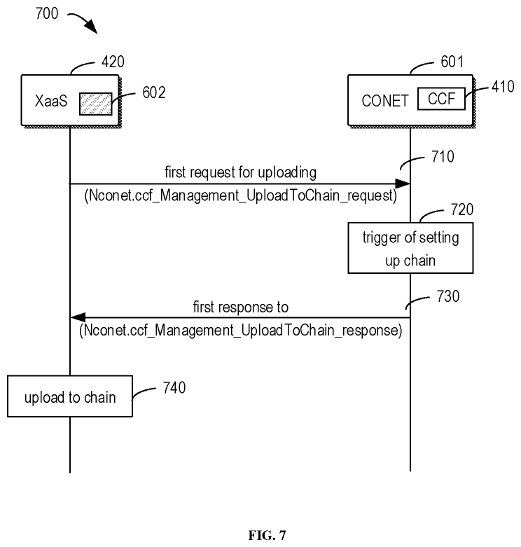

FIG. 8 illustrates an example process 800 for uploading to chain in accordance with some embodiments of the present disclosure. In some embodiments, the process 800 may be regarded as a detailed implementation of the process 700 discussed above. The process 800 may involve a CCF 801, an XaaS entity 802, and a NET4BC 803. With reference to FIG. 5, the CCF 801 may be an example of the CONET module 521, the XaaS entity 802 may be an entity in a XaaS module 420, and the NET4BC 803 may be the NET4BC module 522. It is to be understood that the XaaS entity 802 may be associated with or connected to a CONET agent, and the NET4BC 803 may be associated with or connected to another CONET agent.

When the XaaS entity 802 has some data for uploading to the blockchain, it transmits, at 810, a first request (Nconet.ccf_Management_UploadToChain_request as shown in FIG. 8) to the CCF 801 for requesting to upload its data to the blockchain. For example, the first request may include one or more of the following: an entity ID of the XaaS entity 802, an entity name of the XaaS entity 802, or a dedicated indication indicating a purpose of the first request. For example, the dedicated indication may be carried in a predefined field of the first request. Optionally, the first request may include a service name and/or a service ID of an Xaas service which the XaaS entity 802 locates in.

The CCF 801 may verify, at 820, an identity of the XaaS entity 802 to determine whether to accept the first request. For ease of description, it is assumed that the CCF 801 accepts the first request in the process 800.

It is to be understood that, if a facticity of the identity of the XaaS entity 802 cannot be verified by the CCF 801, the CCF 801 may decide to reject the first request. For example, the CCF 801 may neglect the first request or may transmit a rejection to the XaaS entity 802. In this case, the following operations 830-870 will not be performed.

In the process 800, the CCF 801 transmits, at 830, a third request (Nconet.ccf_Management_ChainInfo_request) to the XaaS entity 802; and may further receive, at 832, a third response (Nconet.ccf_Management_ChainInfo_response) from the XaaS entity 802. The third request may ask the XaaS entity 802 for chain information, and accordingly the third response may include the requested chain information. For example, the third response may include one or more of the following associated with the XaaS entity 802: a service name of an XaaS service which the XaaS entity 802 locates in, a service ID of an XaaS service which the XaaS entity 802 locates in, a group ID of a group which includes the XaaS service, a group name of a group which includes the XaaS service, a contract name/ID of a contract corresponding to the group, and chain requirement of the XaaS entity 802. For example, the third response may include a member ID and a group ID, and the CCF 801 may determine that the member ID is a service ID of an XaaS service which the XaaS entity 802 locates in, and the group ID is of a group which includes the XaaS service. For example, the chain requirement in the third response may indicate a requirement for a topology, a data type, a security level, and a performance request.

The CCF 801 performs a chain profile translation at 834, that is, the CCF 801 may generate a chain profile for the XaaS entity 802. In some embodiments, the chain profile may be generated according to the third response and a service profile associated with the XaaS entity 802. For example, the service profile may be maintained (or recorded, stored) at the CCF 801. With reference to Table 1, a deployment profile and a role profile of the XaaS entity 802 may be considered while generating the chain profile. With reference to Table 4, the chain profile generated at 834 may not include all information, for example, the chain performance is not available while generating the chain profile at 834.

The CCF 801 may transmit, at 840, a second request (Nconet.ccf_Management_SetUpChain_request) to the NET4BC 803. The second request may indicate to the NET4BC 803 to setup a chain for uploading. For example, the second request may include a member ID, a group ID, and a chain profile generated at 834. At 842, the NET4BC 803 may develop a chain and configure chain parameters according to the chain profile. For example, the NET4BC 803 may determine a chain which is corresponding to a group with the group ID, and may configure chain parameters (such as chain performance) for the chain.

At 844, the NET4BC transmits to the CCF 801, and accordingly the CCF 801 receives from the NET4BC 803, a second response (Nconet.ccf_Management_SetUpChain_response). For example, the second response may include a chain ID, chain performance, and a chain URL. Optionally, the second response may include the member ID and the group ID which are the same as that included in the second request.

The CCF 801 keeps, at 850, a chain record mapping based on the second response. In some examples, the CCF 801 may update the chain profile, for example, the chain profile generated at 834 may be updated, e.g. filling the chain performance. In some examples, a chain management table may be maintained at the CCF 801, an entry in the chain management table may be related to the XaaS entity 802. For example, an entry for the XaaS entity 802 may be added into the chain management table, and information of fields in the entry may be determined based on e.g. the second response and the third response. In some examples, the CCF 801 may further determine an upload method for the XaaS entity 802, which may be “abstract”, “URL”, or “content”. Alternatively, the CCF 801 may update the chain management profile, for example, a field of upload method for the entry may be added. As such, a mapping relationship between chain and group may be recorded in the chain management table at the CCF 801.

The CCF 801 may further perform, at 860, upload methods management. In some embodiments, the upload methods management at 860 may refer to interaction methods, which may be different from the “upload method” in the chain management profile. In some examples, the interaction methods may include synchronous methods and/or asynchronous methods. For example, the CCF 801 may manage the interaction methods according to the chain performance, to reduce overhead for NET4BC.

The CCF 801 transmits, at 870, a first response (Nconet.ccf_Management_UploadToChain_response) to the XaaS entity 802, which may inform the XaaS entity 802 to upload data to the blockchain. The first response may include one or more of the following: the group ID, the chain ID, chain URL, upload method, etc. For example, the first response may further include the interaction method. As such, the XaaS entity 802 may further upload the data to the chain, e.g. based on the first response.

It is to be appreciated that the process 800 is illustrated only for examples without any limitation, for example one or more operations may be omitted, for example the order of the operations may be changed, for example some operations may be combined as one operation, for example additional operation(s) may be further considered, for example further component(s) may be involved, the present disclosure does not limit.

It is to be appreciated that although the process 600 and the process 700/800 may be implemented separately, in some cases, the process 700/800 may be combined with the process 600. For example, the process 600 may be regarded as a profile preparation for chain procedure(s), the process 700/800 may be performed after the process 600. For example, some operations in the process 600 and other operations in the process 700/800 may be combined, for example, the group establishment and the chain setup may be performed without a limited order.

It is to be appreciated that current wireless systems, such as 5G systems, are designed to provide only connected services and are managed and operated by a single party or participant (i.e., network operators). It is expected that future wireless systems, such as 6G systems, will go beyond connectivity provision to provide a variety of new services such as artificial intelligence as a service, data management as a service, and more. It is also expected that future wireless systems may be operated by multiple players, part of each participant's operating system, providing certain services for internal use of the system or end customer use. Therefore, it is desirable to design an open system architecture for future wireless systems that is capable of providing any service and can be centered on any player character to support various operating scenarios. The system is expected to be scalable and credible for multi players to work together.

According to some embodiments of the present disclosure with reference to FIGS. 4-8, methods, apparatuses, computer readable storage medium, computer program product for managing a chain for multiple players are provided. In the present solution, an XaaS entity may request for uploading data to the blockchain by sending a first request to a first function, such as a CCF, and accordingly, the CCF may trigger setting up a chain on the blockchain and notify to the XaaS entity of information about the chain. In the present solution, the XaaS entity may upload its data to the chain according to a first response from the CCF. As such, the CCF may control and manage an uploading operation of an XaaS entity, thus, a chain related procedure may be enabled for multiple players and a credible solution may be guaranteed. Therefore, the system can be scalable and credible for multiple players to work together.

According to the present disclosure, a credible solution of CONET for multiple players is provided, which supports a mapping relationship between a group and a chain, a chain management table which manages the mapping, and a chain related procedure for uploading. For example, service profile, group profile, and chain profile are designed for facilitate a management of chain management table.

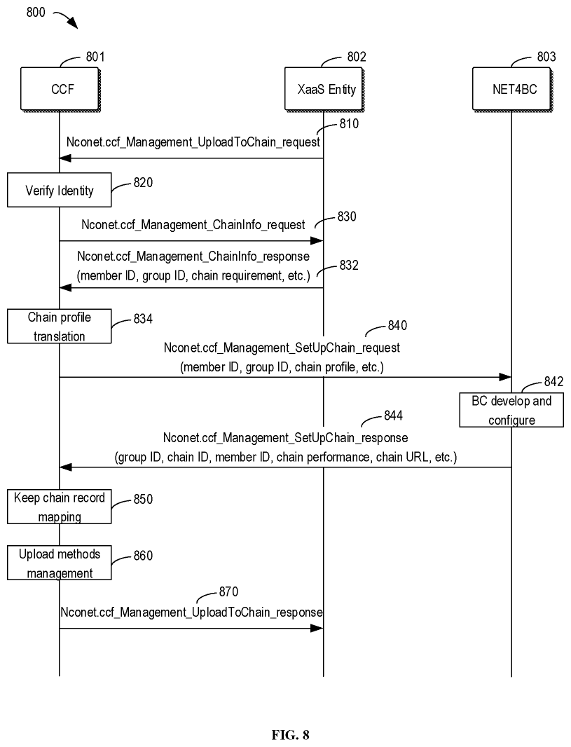

FIG. 9 illustrates a flowchart of an example method 900 implemented at a first function in accordance with some embodiments of the present disclosure. For the purpose of discussion, the first function which may perform the method 900 can be the CCF 410 discussed above.

At block 910, the first function receives, from a second function associated with an XaaS service, a first request for uploading data of an XaaS entity of the XaaS service to a blockchain. At block 920, the first function triggers setting up a chain on the blockchain, where the chain corresponds to a group comprising a plurality of members, and one of the plurality of members is the XaaS service. At block 930, the first function transmits, to the second function, a first response indicating to the XaaS entity to upload the data to the chain on the blockchain.

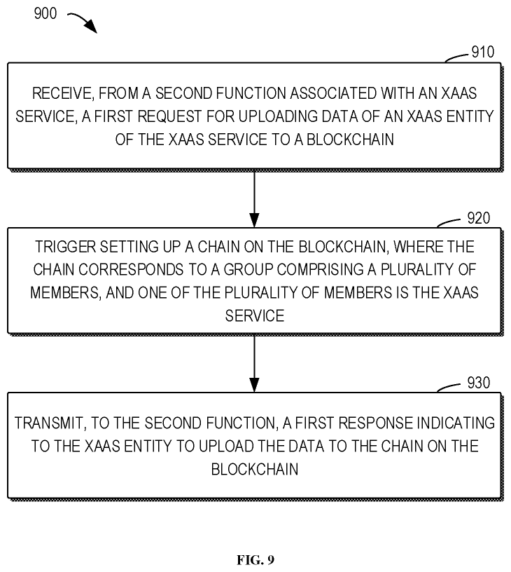

FIG. 10 illustrates a flowchart of an example method 1000 implemented at a second function in accordance with some embodiments of the present disclosure. For the purpose of discussion, the second function which may perform the method 1000 can be the network function 602 of an XaaS service 420 discussed above, for example, the second function may be a TCF or a PF.

At block 1010, the second function transmits, to a first function, a first request for uploading data of an XaaS entity of the XaaS service to a blockchain. At block 1020, the second function receives, from the first function, a first response indicating to the XaaS entity to upload the data to a chain on the blockchain, where the chain corresponds to a group comprising a plurality of members, and one of the plurality of members is the XaaS service. At block 1030, the second function uploads, based on the first response, the data to the chain on the blockchain.

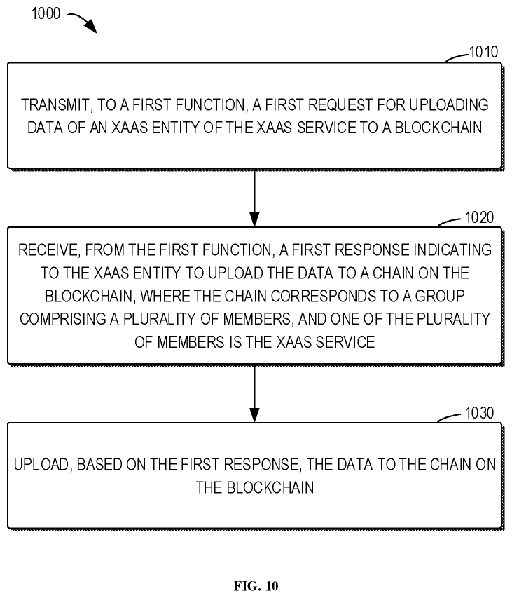

FIG. 11 illustrates a simplified block diagram of an apparatus 1100 according to some example embodiments of the present disclosure. The apparatus 1100 may be implemented as a device or a chip in the device, and the scope of the present application is not limited in this respect. The apparatus 1100 may include multiple modules for performing corresponding processes in the method 900 as discussed in FIG. 9 and related operation performed by the CCF 410 discussed with reference to FIGS. 6-8. The apparatus 1100 may be implemented as the first function (such as the CCF 410 as shown in FIG. 4) or a part of the first function. As illustrated in FIG. 11, the apparatus 1100 comprises a receiving module 1110, a processing module 1120, and a transmitting module 1130. In some embodiments, the receiving module 1110 and the transmitting module 1130 may be implemented as a transceiver.

In some implementations, the receiving module 1110 is configured to receive, from a second function associated with an XaaS service, a first request for uploading data of an Xaas entity of the XaaS service to a blockchain. In some implementations, the processing module 1120 is configured to trigger setting up a chain on the blockchain, where the chain corresponds to a group comprising a plurality of members, and one of the plurality of members is the XaaS service. In some implementations, the transmitting module 1130 is configured to transmit, to the second function, a first response indicating to the XaaS entity to upload the data to the chain on the blockchain.

In some example embodiments, the transmitting module 1130 is configured to transmit, to the blockchain, a second request for setting up the chain, wherein the second request comprises data information of the XaaS entity. In some example embodiments, the receiving module 1110 is configured to receive, from the blockchain, a second response indicating that the chain has been set up on the blockchain.

In some example embodiments, the second response indicates at least one of: a chain name of the chain, a chain ID of the chain, a chain performance of the chain, or location information of the chain on the blockchain.

In some example embodiments, the transmitting module 1130 is configured to transmit, to the second function, a third request for data information of the XaaS entity. In some example embodiments, the receiving module 1110 is configured to receive, from the second function, a third response comprising the data information of the XaaS entity.

In some example embodiments, the data information of the XaaS entity comprises at least one of: a type of the data of the XaaS entity, a topology of the data, a security level of the data, or a performance request of the data.

In some example embodiments, the processing module 1120 is configured to generate a chain profile of the chain, wherein the chain profile comprises at least one of: a chain name, a chain ID, a list of chain requirements, a list of chain performances, or a list of upload methods.

In some example embodiments, the processing module 1120 is configured to determine chain management information of the chain, wherein the chain management information comprises a plurality of entries, a first entry of the plurality of entries is associated with the data of the XaaS entity.

In some example embodiments, the first entry comprises at least one of: a service name of the XaaS service, a service ID of the XaaS service, an entity ID of the XaaS entity, a group ID of the group, a chain ID of the chain, a type of the data of the XaaS entity, a topology of the data, a security level of the data, a performance request of the data, a chain performance of the data, or an upload method for the data.

In some example embodiments, the processing module 1120 is configured to perform a verification of identity information of the XaaS entity.

In some example embodiments, the first response indicates at least one of: a chain name of the chain, a chain ID of the chain, location information of the chain on the blockchain, or an upload method for uploading the data.

In some implementations, the receiving module 1110 is configured to receive, from the second function associated with the XaaS service, a group join request comprising profile information of the XaaS service. In some example embodiments, the processing module 1120 is configured to establish the group based on the group join request.

In some example embodiments, the processing module 1120 is configured to generate group information for the group, wherein the group information indicates at least one of: a group name, a group ID, the plurality of members, or a plurality of member IDs of the plurality of members.

In some example embodiments, the transmitting module 1130 is configured to transmit, to each member in the group, a notification comprising the group information.

In some example embodiments, the processing module 1120 is configured to establish the group based on at least one of: a verification of identity information of the XaaS service, or a confirmation from each of the plurality of members.

In some example embodiments, the profile information of the XaaS service indicates at least one of: a service name of the XaaS service, a service ID of the XaaS service, one or more entity names of one or more entities which the XaaS service comprises, one or more entity IDs of the one or more entities, entity information of the one or more entities, deployment information associated with at least one valid entity in the one or more entities, role information of each of the one or more entities, an action list for each of the one or more entities, or a requirement of the XaaS service.

The apparatus 1100 can be used to implement some embodiments at the CCF 410 described with reference to FIGS. 4-10.

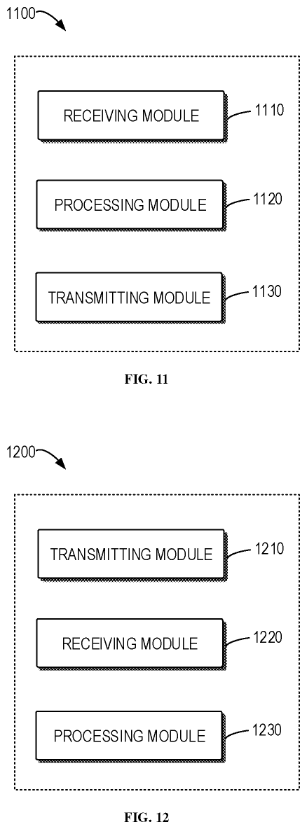

FIG. 12 illustrates a simplified block diagram of an apparatus 1200 according to some example embodiments of the present disclosure. The apparatus 1200 may be implemented as a device or a chip in the device, and the scope of the present application is not limited in this respect. The apparatus 1200 may include multiple modules for performing corresponding processes in the method 1000 as discussed in FIG. 10 and related operation performed by the network module 602 discussed with reference to FIGS. 6-8. The apparatus 1200 may be implemented as the second function (such as the TCF or the PF of an XaaS module 420 as shown in FIG. 4) or a part of the second function. As illustrated in FIG. 12, the apparatus 1200 comprises a transmitting module 1210, a receiving module 1220, and a processing module 1230. In some embodiments, the receiving module 1220 and the transmitting module 1210 may be implemented as a transceiver.

In some implementations, the transmitting module 1210 is configured to transmit, to a first apparatus (such as the CCF 410), a first request for uploading data of an XaaS entity of the XaaS service to a blockchain. In some implementations, the receiving module 1220 is configured to receive, from the first function, a first response indicating to the XaaS entity to upload the data to a chain on the blockchain, where the chain corresponds to a group comprising a plurality of members, and one of the plurality of members is the XaaS service. In some implementations, the processing module 1230 is configured to upload, based on the first response which is received from the receiving module 1220, the data to the chain on the blockchain.

In some example embodiments, the receiving module 1220 may be further configured to receive, from the first function, a third request for data information of the XaaS entity. In some example embodiments, the transmitting module 1210 is configured to transmit, to the first function, a third response comprising the data information of the XaaS entity.

In some example embodiments, the data information of the XaaS entity comprises at least one of: a type of the data of the XaaS entity, a topology of the data, a security level of the data, or a performance request of the data.

In some example embodiments, the first response indicates at least one of: a chain name of the chain, a chain ID of the chain, location information of the chain on the blockchain, or an upload method for uploading the data.

In some example embodiments, chain management information of the chain is stored at the first function, wherein the chain management information comprises a plurality of entries, a first entry of the plurality of entries is associated with the data of the XaaS entity.

In some example embodiments, the first entry comprises at least one of: a service name of the XaaS service, a service ID of the XaaS service, an entity ID of the XaaS entity, a group ID of the group, a chain ID of the chain, a type of the data of the XaaS entity, a topology of the data, a security level of the data, a performance request of the data, a chain performance of the data, or an upload method for the data.

In some example embodiments, the processing module 1230 is configured to determine to join a group managed by the first function. In some example embodiments, the transmitting module 1210 is configured to transmit, to the first function, a group join request comprising profile information of the XaaS service.

In some example embodiments, the receiving module 1220 may be further configured to receive, from the first function, a notification comprising group information of the group established based on the group join request, wherein the group information indicates at least one of: a group name, a group ID, the plurality of members, or a plurality of member IDs of the plurality of members.

In some example embodiments, the profile information of the XaaS service indicates at least one of: a service name of the XaaS service, a service ID of the XaaS service, one or more entity names of one or more entities which the XaaS service comprises, one or more entity IDs of the one or more entities, entity information of the one or more entities, deployment information associated with at least one valid entity in the one or more entities, role information of each of the one or more entities, an action list for each of the one or more entities, or a requirement of the XaaS service.

The apparatus 1200 can be used to implement some embodiments at the network function of an XaaS module 420 described with reference to FIGS. 4-10.

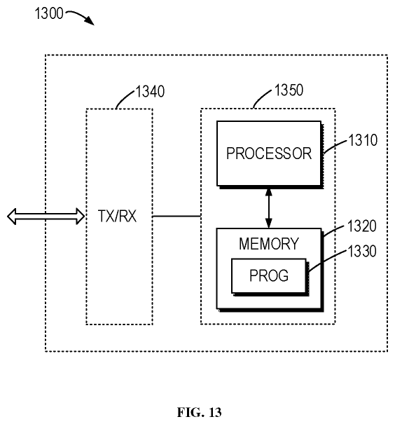

FIG. 13 illustrates an example block diagram of a device 1300 that may be used to implement some embodiments of the present disclosure. The device 1300 can be considered as a further example implementation (e.g., part) of the first function and the second function as discussed above, e.g., the CCF 410, the network function 602 (such as the TCF or PF) of an XaaS service 420.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications.

The program 1330 is assumed to include program instructions that, when executed by the associated processor 1310, enable the device 1300 to operate in accordance with the embodiments of the present disclosure, as discussed herein with reference to FIGS. 1-12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The present disclosure provides a device or an apparatus, comprising: a processor; and a memory storing computer program codes; the memory and the computer program codes configured to, with the processor, cause the device or the apparatus to perform the method implemented at the first function or the second function discussed above.

The present disclosure provides a computer readable medium having instructions stored thereon, the instructions, when executed by a processor of an apparatus, causing the apparatus to perform the method implemented at the first function or the second function discussed above.

The present disclosure provides a computer program product comprising instructions, the instructions, when executed by a processor of an apparatus, causing the apparatus to perform the method implemented at the first function or the second function discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method performed by a first function, the method comprising:
receiving, from a second function associated with an anything as a service (XaaS) service, a first request for uploading data of an XaaS entity of the XaaS service to a blockchain;
triggering setting up of a chain on the blockchain, wherein the chain corresponds to a group comprising a plurality of members, and one of the plurality of members is the XaaS service; and
transmitting, to the second function, a first response indicating to the XaaS entity to upload the data to the chain on the blockchain.

2. The method of claim 1, wherein triggering setting up of the chain comprises:
transmitting, to the blockchain, a second request for setting up the chain, wherein the second request comprises data information of the XaaS entity; and
receiving, from the blockchain, a second response indicating that the chain has been set up on the blockchain.

3. The method of claim 2, wherein the second response indicates at least one of:
a chain name of the chain,
a chain ID of the chain,
a chain performance of the chain, or
location information of the chain on the blockchain.

4. The method of claim 1, further comprising:
transmitting, to the second function, a third request for data information of the Xaas entity; and
receiving, from the second function, a third response comprising the data information of the XaaS entity.

5. The method of claim 2, wherein the data information of the XaaS entity comprises at least one of:
a type of the data of the XaaS entity,
a topology of the data,
a security level of the data, or
a performance request of the data.

6. The method of claim 1, wherein triggering setting up of the chain comprises:
generating a chain profile of the chain, wherein the chain profile comprises at least one of:
a chain name,
a chain ID,
a list of chain requirements,
a list of chain performances, or
a list of upload methods.

7. The method of claim 1, wherein triggering setting up of the chain comprises:
determining chain management information of the chain, wherein the chain management information comprises a plurality of entries, a first entry of the plurality of entries is associated with the data of the XaaS entity.

8. The method of claim 7, wherein the first entry comprises at least one of:
a service name of the XaaS service,
a service ID of the XaaS service,
an entity ID of the XaaS entity,
a group ID of the group,
a chain ID of the chain,
a type of the data of the XaaS entity,
a topology of the data,
a security level of the data,
a performance request of the data,
a chain performance of the data, or
an upload method for the data.

9. The method of claim 1, further comprising:
before triggering setting up of the chain, performing a verification of identity information of the XaaS entity.

10. The method of claim 1, wherein the first response indicates at least one of:
a chain name of the chain,
a chain ID of the chain,
location information of the chain on the blockchain, or
an upload method for uploading the data.

11. The method of claim 1, further comprising:
receiving, from the second function associated with the XaaS service, a group join request comprising profile information of the XaaS service; and
establishing the group based on the group join request.

12. The method of claim 11, wherein establishing the group is based on at least one of:
a verification of identity information of the XaaS service, or
a confirmation from each of the plurality of members.

13. The method claim 11, wherein the profile information of the XaaS service indicates at least one of:
a service name of the XaaS service,
a service ID of the XaaS service,
one or more entity names of one or more entities which the XaaS service comprises,
one or more entity IDs of the one or more entities,
entity information of the one or more entities,
deployment information associated with at least one valid entity in the one or more entities,
role information of each of the one or more entities,
an action list for each of the one or more entities, or
a requirement of the XaaS service.

14. A method performed by a second function associated with an anything as a service (XaaS) service, the method comprising:
transmitting, to a first function, a first request for uploading data of an XaaS entity of the XaaS service to a blockchain;
receiving, from the first function, a first response indicating to the XaaS entity to upload the data to a chain on the blockchain, wherein the chain corresponds to a group comprising a plurality of members, and one of the plurality of members is the XaaS service; and
uploading, based on the first response, the data to the chain on the blockchain.

15. The method of claim 14, further comprising:
receiving, from the first function, a third request for data information of the XaaS entity; and
transmitting, to the first function, a third response comprising the data information of the XaaS entity.

16. The method of claim 15, wherein the data information of the XaaS entity comprises at least one of:
a type of the data of the XaaS entity,
a topology of the data,
a security level of the data, or
a performance request of the data.

17. The method of claim 14, wherein the first response indicates at least one of:
a chain name of the chain,
a chain ID of the chain,
location information of the chain on the blockchain, or
an upload method for uploading the data.

18. The method of claim 14, wherein chain management information of the chain is stored at the first function, wherein the chain management information comprises a plurality of entries, a first entry of the plurality of entries is associated with the data of the XaaS entity.

19. The method claim 14, further comprising:
determining to join a group managed by the first function; and
transmitting, to the first function, a group join request comprising profile information of the XaaS service.

20. A communication system comprising:
a first function; and
a second function associated with an anything as a service (XaaS) service;
wherein the first function is configured to:
receive, from the second function, a first request for uploading data of an XaaS entity of the XaaS service to a blockchain;
trigger setting up of a chain on the blockchain, wherein the chain corresponds to a group comprising a plurality of members, and one of the plurality of members is the XaaS service; and
transmit, to the second function, a first response indicating to the XaaS entity to upload the data to the chain on the blockchain; and
wherein the second function is configured to:
transmit, to the first function, the first request for uploading the data of the XaaS entity of the XaaS service to the blockchain;
receive, from the first function, the first response indicating to the XaaS entity to upload the data to the chain on the blockchain; and
upload, based on the first response, the data to the chain on the blockchain.
